(19) United States
(12) Patent Application Publication
(10) Pub. No.: US 2025/0362523 A1
(43) Pub. Date: Nov. 27, 2025

(54) Lens Driving Device

(71) Applicant: AAC Microtech (Changzhou) Co., Ltd., Changzhou City (CN)

(72) Inventors: Bo Xiao, Changzhou (CN); Ronglin Linghu, Changzhou (CN); Tong Zhang, Changzhou (CN); Wei Song, Changzhou (CN)

(21) Appl. No.: 18/985,091

(22) Filed: Dec. 18, 2024

Related U.S. Application Data
(63) Continuation of application No. PCT/CN2024/094861, filed on May 23, 2024.

(51) Int. Cl. G02B 27/64; G02B 7/09; G03B 17/12

(52) U.S. Cl. CPC G02B 27/646; G02B 7/09; G03B 17/12

(57) ABSTRACT

The present invention provides a lens driving device including a housing having a through hole, a lens partially extending beyond the housing, a carrier frame carrying the lens, a support frame arranged around the carrier frame, at least one elastic element elastically connecting the carrier frame to the support frame, a first driving assembly, and a second driving assembly. The lens includes an optical axis. The first driving assembly drives the carrier frame and the lens to move in a direction along the optical axis. The second driving assembly drives the support frame, the carrier frame, and the lens to move in a direction perpendicular to the optical axis. The elastic element being made of polymer material. The lens driving device of the present invention uses a polymer elastic element, which can provide a larger movement distance of the lens and higher reliability of the elastic element.

### FIELD OF THE PRESENT INVENTION

The present invention relates to the field of lens, and more particularly, to a lens driving device.

### DESCRIPTION OF RELATED ART

Recently, in addition to portable cameras, portable terminals such as smartphones and tablets have also been equipped with high-performance lens driving devices. The high-performance lens driving device configured on portable terminals generally has auto focusing (AF) and optical image stabilization (OIS) functions. Optical image stabilization (OIS) can reduce photo shake caused by external vibrations or hand tremors of user.

In related art, in the lens driving device, the springs used in the structure related to the auto focusing function are generally metal springs, mostly made of copper or stainless steel, with a two-layer structure which having upper layer and lower layer, and each layer having four springs. In this structure, the springs occupy too much space in the lens driving device and are easy to breakage in drop experiments.

Therefore, it is desired to provide a new lens driving device which can overcome the above problems.

### SUMMARY

In view of the above, the embodiments of the present invention provide a new lens driving device with a stable structure and high reliability.

The present invention provides a lens driving device including a housing having a through hole, a lens located in the housing and partially extending out of the housing, a carrier frame carrying the lens, a support frame arranged around the carrier frame, at least one elastic element elastically connecting the carrier frame to the support frame, a first driving assembly located at a position of a corner of the lens driving device, and a second driving assembly located at the position of another corner of the lens driving device. The lens includes an optical axis. The first driving assembly drives the carrier frame and the lens to move in a direction along the optical axis. The second driving assembly drives the support frame, the carrier frame, and the lens to move in a direction perpendicular to the optical axis. The elastic element being made of polymer material.

As an improvement, the elastic element is wave-shaped.

As an improvement, the lens driving device further includes a first metal member fixing one end of the elastic element to the carrier frame, and/or a second metal member fixing the other end of the elastic element to the support frame.

As an improvement, the elastic element is made of at least one of silicone, rubber, polyetheretherketone, or polyimide.

As an improvement, the elastic element includes at least one first elastic element arranged on a side of the carrier frame close to the through hole and at least one second elastic element arranged on the other side of the carrier frame away from the through hole, and the first elastic element is a ring-shaped structure, and/or the second elastic element is a ring-shaped structure.

As an improvement, the elastic element includes at least one first elastic element arranged on a side of the carrier frame close to the through hole and at least one second elastic element arranged on the other side of the carrier frame away from the through hole, a number of the first elastic elements is multiple, the first elastic elements spaced apart from each other, and/or the number of the second elastic element is multiple, the adjacent second elastic elements spaced apart from each other.

As an improvement, the first driving assembly includes a magnetic case having a containment space fixed to the support frame, a first magnetic assembly located in the containment space, and a first coil arranged around the first magnetic assembly, the magnetic case provided with a notch, and the carrier frame including an extension arm fixedly connected to the first coil through the notch.

As an improvement, the second driving assembly includes a first magnet assembly fixed to the housing and arranged along a straight side forming the corner, a first driving coil spaced apart from a side of the first magnet assembly close to the through hole, a second magnet assembly arranged along another straight side forming the corner, and a second driving coil spaced apart from the side of the second magnet assembly close to the through hole, the first driving coil and the second driving coil fixed to the support frame.

As an improvement, the lens driving device further includes a first circuit board electrically connected to the first coil, one end of the first circuit board fixed to the carrier frame, and the other end of the first circuit board fixed to the support frame.

As an improvement, the lens driving device further includes at least one elastic support member elastically supporting the support frame, the elastic support member including a first support portion fixed to the housing, a pair of second support portions fixed on opposite sides of the support frame, and a pair of connecting portions, each connecting portion connecting the first support portion and the corresponding second support portion.

As an improvement, the number of first driving assemblies is two, two first driving assemblies spaced apart from each other at two corners along one diagonal of the housing, the number of second driving assemblies is two, two second driving assemblies spaced apart from each other at two corners along another diagonal of the housing.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a lens driving device in accordance with one embodiment of the present invention.

FIG. 2 is a partially exploded view of the lens driving device of FIG. 1.

FIG. 3 is another partially exploded view of the lens driving device of FIG. 1 from another perspective.

FIG. 4 is an exploded view of the lens driving device of FIG. 1.

FIG. 5 is an illustrative cross-sectional view of the lens driving device taken along line A-A of FIG. 1.

FIG. 6 is an illustrative cross-sectional view of the lens driving device taken along line B-B of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

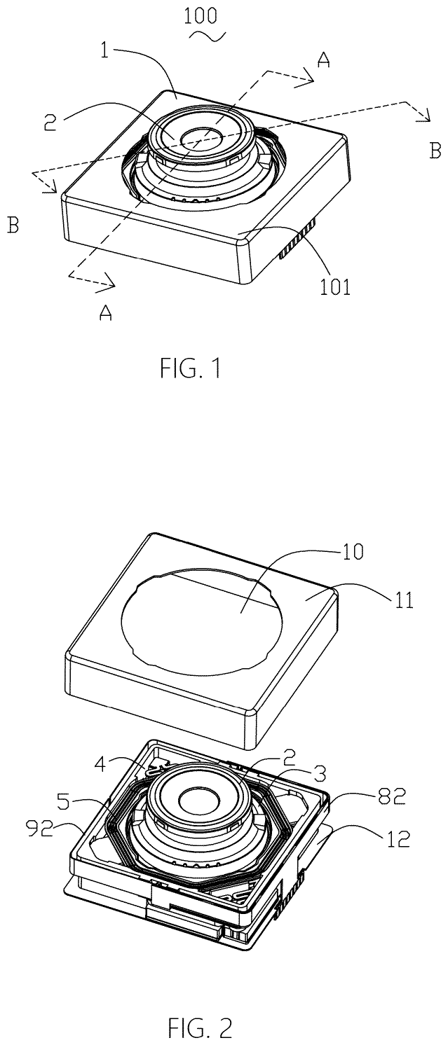

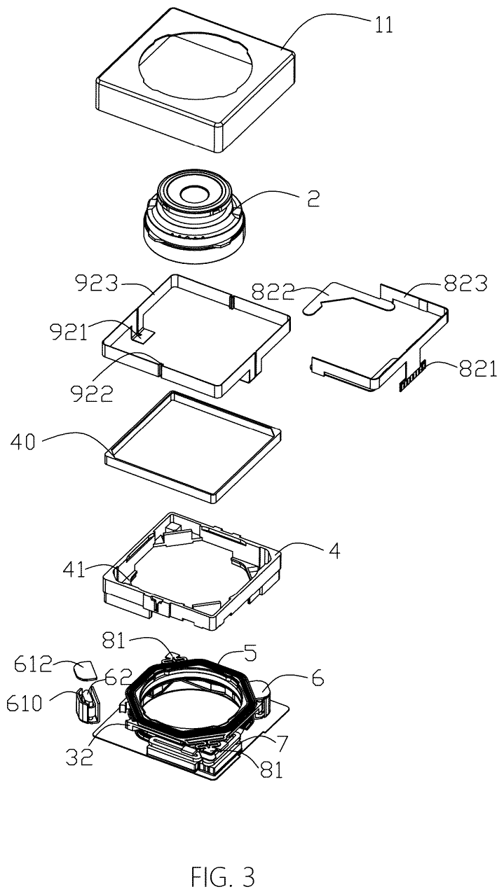

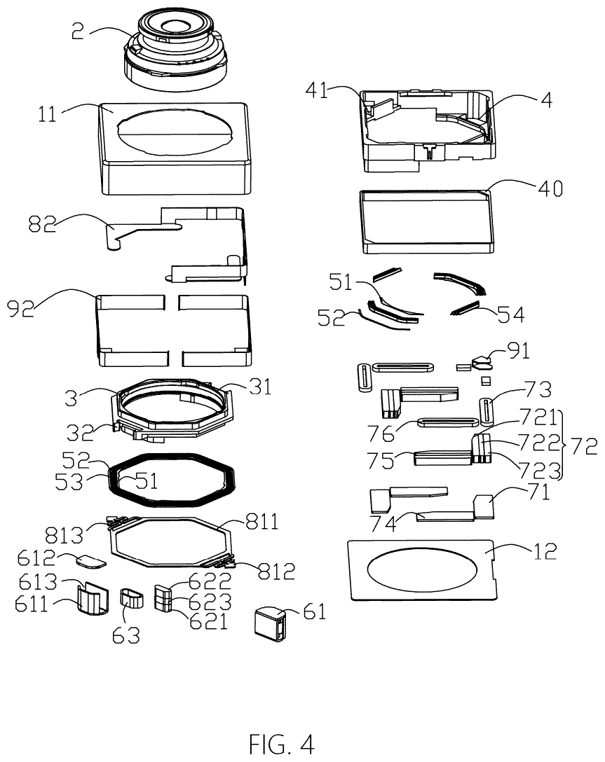

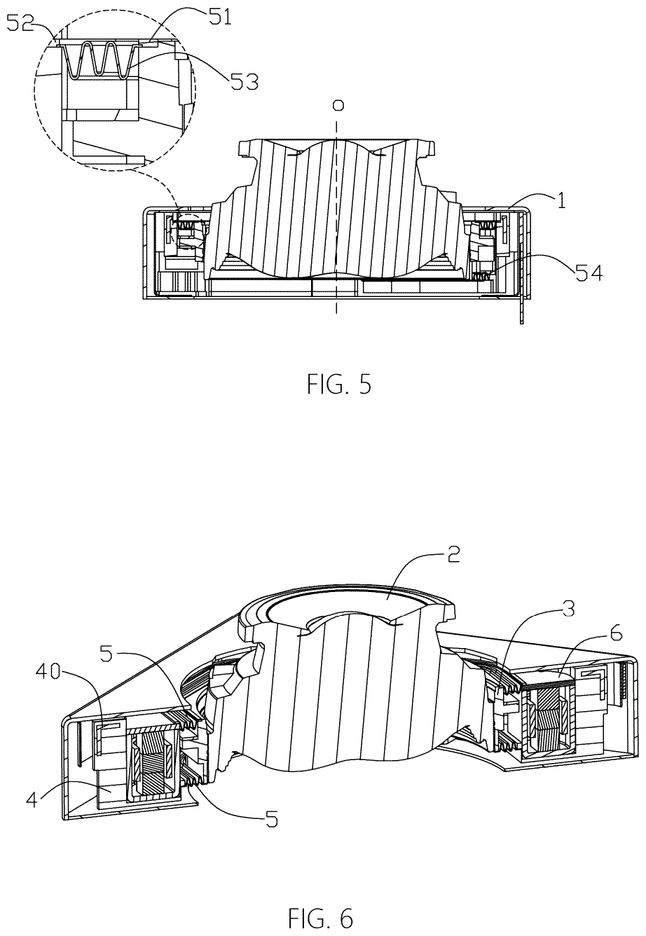

Referring to the FIGS. 1-6, the present invention provides a lens driving device 100. The lens driving device 100 includes a housing 1 having a through hole 10, a lens 2 located in the housing 1 and partially extending out of the housing 1, a carrier frame 3 carrying the lens 2, a support frame 4 arranged around the carrier frame 3, at least one elastic element 5 elastically connecting the carrier frame 3 to the support frame 4, a first driving assembly 6 located at a position of a corner 101 of the lens driving device 100, a second driving assembly 7 located at the position of another corner 101 of the lens driving device 100, a first circuit board 81, a second circuit board 82, an electrical connector 91, and at least one elastic support member 92.

The housing 1 includes a cover 11 and a bottom plate 12 covered with the cover 11 to form an accommodating space. The through hole 10 is provided on the cover 11, and the bottom plate 12 is also provided with a perforation passing through it.

The lens 2 includes an optical axis O.

The carrier frame 3 is arranged around the lens 2 and carries the lens 2. The carrier frame 3 includes a hollow annular main body 31 and a plurality of extension arms 32 extending outwardly from the main body 31. The extension arms 31 are formed at the position of the corner s101 of the lens driving device 100, and each of the two corners 101 at a diagonal position of the lens driving device 100 is provided with a pair of extension arms 32.

The support frame 4 is a hollow annular structure, and the lens driving device 100 further includes a reinforcing ring 40 embedded inside the support frame 4. The reinforcing ring 40 is made of metal material to improve the strength and stability of the support frame 4. The support frame 4 is equipped with a pair of bearing platforms 41 at the position of the corners 101 corresponding to the extension arms 32, and the first driving assembly 6 is fixed on the bearing platform 41.

The elastic element 5 is arranged between the carrier frame 3 and the support frame 4 to elastically support the carrier frame 3. The elastic element 5 is made of polymer material. Specifically, the elastic element is made of at least one of silicone, rubber, polyetheretherketone, or polyimide. In present embodiment, the elastic element is wave-shaped. In other embodiments, the elastic element 5 can also be in other shapes with excellent elasticity, such as serrated shapes.

The lens driving device 100 further includes a first metal member 51 fixing one end of the elastic element 5 to the carrier frame 3, and/or a second metal member 52 fixing the other end of the elastic element 5 to the support frame 4. The first metal member 51 and/or the second metal member 52 are pressed at an edge position of the elastic element 5, so that the elastic element 5 can be stably fixed to the carrier frame 3 and the support frame 4. Of course, the lens driving device 100 may not be equipped with the first metal member 51 and the second metal member 52. In this way, the elastic element 5 can be directly fixed to the carrier frame 3 and the support frame 4, which can be fixed by adhesive or other fixing methods.

The elastic element 5 includes at least one first elastic element 53 arranged on a side of the carrier frame 3 close to the through hole 10 and at least one second elastic element 54 arranged on the other side of the carrier frame 3 away from the through hole 10. In present embodiment, there is one first elastic element 53, and the one first elastic element 53 is a ring-shaped structure, and correspondingly, the first metal member 51 and the second metal member 52 are also ring-shaped structures. In other embodiments, the elastic element 5 includes a plurality of first elastic elements 53 arranged on a side of the carrier frame 3 close to the through hole 10. The first elastic elements 53 are spaced apart from each other. Correspondingly, the number of the first metal members 51 and the second metal members 52 that fix the first elastic elements 53 are also multiple. In present embodiment, the elastic element 5 includes a plurality of second elastic elements 54 arranged on the other side of the carrier frame 3 away from the through hole 10, and the second elastic elements 54 are spaced apart from each other. Specifically, the number of second elastic elements 54 is four, and correspondingly, the number of the first metal members 51 and the second metal members 52 that fix the second elastic elements 54 are also multiple. Some of the second elastic elements 54 are directly glued and fixed to the carrier frame 3 and the support frame 4. In other embodiments, the second elastic element 54 may also be the ring-shaped structure, and correspondingly, the first metal member 51 and the second metal member 52 that fix the second elastic element 54 are also the ring-shaped structures.

The number of the first driving assemblies 6 is two, and two first driving assemblies 6 are arranged spaced apart from each other at two corners 101 along one diagonal of the housing 1. The first driving assemblies 6 drive the carrier frame 3 and the lens 2 to move in a direction along the optical axis O. Each first driving assembly 6 includes a magnetic case 61 fixed to the support frame 4 and having a containment space 610, a first magnetic assembly 62 located in the containment space 610, and a first coil 63 arranged around the first magnetic assembly 62. The magnetic case 61 is made of a magnetic conductive material and includes a frame portion 611 and a cover portion 612 covering the frame portion 611. The frame portion 611 is provided with a notch 613, and the extension arms 32 of the carrier frame 3 are fixedly connected to the first coil 63 through the notch 613.

The first magnetic assembly 62 includes a first magnet 621, a second magnet 622 disposed above the first magnet 621, and a pole plate 623 sandwiched between the first magnet 621 and the second magnet 622. The first magnet 621 and the second magnet 622 are magnetized in the direction along the optical axis O, and the first magnet 621 and the second magnet 622 are set opposite to each other with a same pole.

The number of the second driving assemblies 7 is two, and two second driving assemblies 7 are arranged spaced apart from each other at two corners 101 along another diagonal of the housing 1. The second driving assemblies 7 drive the support frame 4, the carrier frame 3, and the lens 2 to move in a direction perpendicular to the optical axis O. Each second driving assembly 7 includes a first lower plate 71 mounted on the bottom plate 12 and arranged along a straight side forming the corner 101, a first magnet assembly 72 located on the first lower plate 71, a first driving coil 73 spaced apart from a side of the first magnet assembly 72 close to the through hole 10, a second lower plate 74 mounted on the bottom plate 12 and arranged along another straight side forming the corner 101, a second magnet assembly 75 located on the second lower plate 74, and a second driving coil 76 spaced apart from the side of the second magnet assembly 75 close to the through hole 10. The first driving coil 73 and the second driving coil 76 are fixed to the support frame 4. The first lower plate 71 and the second lower plate 74 are made of magnetic conductive materials.

Taking the first magnet assembly 72 as an example, the first magnet assembly 72 includes a first driving magnet 721, a second driving magnet 722, and a third driving magnet 723 arranged side by side. The first driving magnet 721 and the third driving magnet 723 are magnetized in the direction along the optical axis O, and the first driving magnet 721 and the third driving magnet 723 are magnetized in opposite directions. The second driving magnet 722 is magnetized along the direction perpendicular to the optical axis O.

The first circuit board 81 is electrically connected to the first coil 63. One end of the first circuit board 81 is fixed to the carrier frame 3, and the other end of the first circuit board 81 is fixed to the support frame 4. Specifically, the first circuit board 81 includes a first contact portion 811 fixed to the carrier frame 3, a second contact portion 812 fixed to the support frame 4, and a connecting portion 813 connecting the first contact portion 811 and the second contact portion 812. The first contact portion 811 is a ring-shaped structure.

The second circuit board 82 includes a first conductive portion 821 extending out of the housing 1, a second conductive portion 822 fixed to a bottom surface of the support frame 4, and a transition portion 823 connecting the first conductive portion 821 and the second conductive portion 822. The second circuit board 82 is directly electrically connected to the first driving coil 73 and the second driving coil 76 to supply power to the first driving coil 73 and the second driving coil 76.

The first coil 63 is connected to the first contact portion 811 of the first circuit board 81, and the second contact portion 812 of the first circuit board 81 is connected to the second conductive portion 822 of the second circuit board 82 through the electrical connector 91, thereby making the first coil 63 to be energized.

The electrical connector 91 is made of metal material. One end of the electrical connector 91 is sandwiched between the first circuit board 81 and the support frame 4, and the other end of the electrical connector 91 is sandwiched between the first driving coil 73 and the support frame 4.

The number of the elastic support members 92 is two. The elastic support members 92 elastically support the support frame 4. Each elastic support member 92 includes a first support portion 921 fixed to the bottom plate 12 of the housing 1, a pair of second support portions 922 fixed on opposite sides of the support frame 4, and a pair of connecting portions 923 connecting the first support portion 921 and the corresponding second support portion 922.

Comparing with the related art, the present invention provides a lens driving device including a housing having a through hole, a lens located in the housing and partially extending beyond the housing, a carrier frame carrying the lens, a support frame arranged around the carrier frame, at least one elastic element elastically connecting the carrier frame to the support frame, a first driving assembly located at a position of a corner of the lens driving device, and a second driving assembly located at the position of another corner of the lens driving device. The lens includes an optical axis. The first driving assembly drives the carrier frame and the lens to move in a direction along the optical axis. The second driving assembly drives the support frame, the carrier frame, and the lens to move in a direction perpendicular to the optical axis. The elastic element being made of polymer material. The lens driving device of the present invention uses an elastic element made of polymer material, which occupies a small space and can provide a larger movement distance of the lens during auto focusing. At the same time, the reliability of the elastic element is higher during the anti-drop and anti-fatigue testing of the lens driving device.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A lens driving device, comprising:
a housing having a through hole;
a lens located in the housing and partially extending out of the housing, the lens comprising an optical axis;
a carrier frame carrying the lens;
a support frame arranged around the carrier frame;
at least one elastic element elastically connecting the carrier frame to the support frame, the elastic element being made of polymer material;
a first driving assembly located at a position of a corner of the lens driving device, the first driving assembly driving the carrier frame and the lens to move in a direction along the optical axis; and
a second driving assembly located at the position of another corner of the lens driving device, the second driving assembly driving the support frame, the carrier frame, and the lens to move in a direction perpendicular to the optical axis.

2. The lens driving device as described in claim 1, wherein the elastic element is wave-shaped.

3. The lens driving device as described in claim 1, wherein the lens driving device further comprises a first metal member fixing one end of the elastic element to the carrier frame, and/or a second metal member fixing the other end of the elastic element to the support frame.

4. The lens driving device as described in claim 1, wherein the elastic element is made of at least one of silicone, rubber, polyetheretherketone, or polyimide.

5. The lens driving device as described in claim 1, wherein the elastic element comprises at least one first elastic element arranged on a side of the carrier frame close to the through hole and at least one second elastic element arranged on the other side of the carrier frame away from the through hole, and the first elastic element is a ring-shaped structure, and/or the second elastic element is a ring-shaped structure.

6. The lens driving device as described in claim 1, wherein the elastic element comprises at least one first elastic element arranged on a side of the carrier frame close to the through hole and at least one second elastic element arranged on the other side of the carrier frame away from the through hole, a number of the first elastic elements is multiple, the first elastic elements spaced apart from each other, and/or the number of the second elastic elements is multiple, the adjacent second elastic elements spaced apart from each other.

7. The lens driving device as described in claim 1, wherein the first driving assembly comprises a magnetic case having a containment space fixed to the support frame, a first magnetic assembly located in the containment space, and a first coil arranged around the first magnetic assembly, the magnetic case provided with a notch, and the carrier frame comprising an extension arm fixedly connected to the first coil through the notch.

8. The lens driving device as described in claim 1, wherein the second driving assembly comprises a first magnet assembly fixed to the housing and arranged along a straight side forming the corner, a first driving coil spaced apart from a side of the first magnet assembly close to the through hole, a second magnet assembly arranged along another straight side forming the corner, and a second driving coil spaced apart from the side of the second magnet assembly close to the through hole, the first driving coil and the second driving coil fixed to the support frame.

9. The lens driving device as described in claim 7, wherein the lens driving device further comprises a first circuit board electrically connected to the first coil, one end of the first circuit board fixed to the carrier frame, and the other end of the first circuit board fixed to the support frame.

10. The lens driving device as described in claim 1, wherein the lens driving device further comprises at least one elastic support member elastically supporting the support frame, the elastic support member comprising a first support portion fixed to the housing, a pair of second support portions fixed on opposite sides of the support frame, and a pair of connecting portions, each connecting portion connecting the first support portion and the corresponding second support portion.

11. The lens driving device as described in claim 1, wherein the number of first driving assemblies is two, two first driving assemblies spaced apart from each other at two corners along one diagonal of the housing, the number of second driving assemblies is two, two second driving assemblies spaced apart from each other at two corners along another diagonal of the housing.
